(19) United States
(12) Patent Application Publication
(10) Pub. No.: US 2009/0266770 A1
(43) Pub. Date: Oct. 29, 2009

(54) METHOD FOR MAINTAINING THE WATER BALANCE IN A WATER PURIFICATION SYSTEM

(75) Inventors: Janne Jamse, Djurhamn (SE); Svante Lind, Stavsnas (SE); Magnus Annell, Djurhamn (SE)

Correspondence Address: YOUNG & THOMPSON, 209 Madison Street, Suite 500, ALEXANDRIA, VA, 22314, US

(73) Assignee: NORDIC ECOSEPTICTANK HB, DJURHAMN (SE)

(21) Appl. No.: 12/119,540

(22) Filed: May 13, 2008

(30) Foreign Application Priority Data
Apr. 24, 2008 (SE) 0800942-5

(51) Int. Cl. C02F 1/00

(52) U.S. Cl. 210/744; 210/747

(57) ABSTRACT

Method for maintaining the water balance in a device (4;5) including a container for waste that has been separated from the waste water, the device (4;5) constituting a part of a permanently installed water purification system for purification of waste water from a building (2). The method is characterised in that the same quantity of water that is removed from the container during sludge suction is replenished to the container before the device (4;5) again is put into full operation.

The present invention relates to a method in connection to a container in a water purification system. Specifically, the present invention refers to a method for maintaining the water balance in a device comprising a container for collecting waste which has been separated from waste water, particularly when the device constitutes a part of a water purification system constituting a permanent installation in connection with a building.

Many real estates, specifically real estates with small houses outside of densely built-up areas, are not connected to municipal sewage. In such real estates, waste water is generally treated in a local water purification system, where waste water is purified from contaminants and subsequently released into nature, for instance into the ground or a watercourse.

There are such local water purification systems that treat both greywater, i.e. waste water not containing any toilet waste, and blackwater, i.e. waste water containing toilet waste.

One example of such a system is one comprising a sludge separator followed by an infiltration device. The sludge separator, which for example may be constituted by a two or three compartment septic tank through which the waste water flows, separates floating and sinking particles that remain in the sludge separator. The infiltration device purifies and distributes the remaining sludge separated water in the ground for further purification, for instance through an existing bacteria culture in the infiltration device. When blackwater is to be purified, among other things a sludge separator having special properties is generally required. Other types of particle separating devices than sludge separators may also occur. There are also devices that precipitate contaminants that are dissolved in the waste water, and devices that contain solid materials that bind existing contaminants in the waste water.

Consequently, such systems produce waste in the form of sludge or the like, that needs to be removed from the device and thereafter either to be removed from the real estate and taken to a plant for storage, purification, composting or digestion, or to be treated locally at the real estate by for example composting. Emptying of such a device is typically performed on a periodical basis, for example 1-2 times per year, for instance by sludge suction by means of a sludge suction truck.

The sludge separator generally contains some water. When the sludge is removed from the container, this water is also removed. This means that the sludge separator is drained or almost drained. When the operation of the purification system is resumed, a number of problems arise.

Firstly, the risk for so called sludge flight increases, i.e. that a part of the remaining floating sludge in the sludge separator spreads downstream in the purification system. Namely, sludge separators typically comprise several successive tanks that are connected by means of holes at different water depths in order to restrain floating and sinking particles from spreading to the next consecutive tank. When the water surface in the sludge separator again rises from a low level close to the bottom, as new waste water flows into the inlet of the sludge separator, the surface will pass such holes that are intended for preventing the spreading of floating particles, whereby such particles are spread to a downstream tank. Sludge flight may lead to clogging and/or that the purification efficiency of the infiltration device decreases. Simultaneously, the life time of the infiltration bed is shortened.

Secondly, some time will pass, possibly several weeks, before the sludge separator again is so full of waste water that sludge separated water again starts to flow on to purification steps provided downstream of the sludge separator, for example an infiltration bed. This leads to that such steps provided downstream dry out before they are remoistened by sludge separated water. The drainage will have the consequence that biological purification steps, such as a bacteria culture existing in the infiltration bed, are damaged. Thereafter, the biological purification is resumed only after some delay, depending on the rate of regeneration of the bacteria culture. During this delay, the biological purification step suffers from bad efficiency, and partially contaminated water is therefore released into nature, which may lead to, for example, contaminated ground water.

Thirdly, in many cases the fresh water comprised in the sewage water is taken from the real estate, for example from a dug well. In these cases, sludge suction with a sludge suction truck implies a net removal of ground water from the real estate. Since relatively large quantities of water may be affected, the risk increases for disturbance of the ground water balance in or around the real estate, which may result for instance in salt water penetration and dried-out wells.

The present invention solves the above described problems.

Thus, the present invention relates to a method for maintaining the water balance in a device comprising a container for waste that has been separated from the waste water, the device constituting a part of a permanently installed water purification system for purification of waste water from a building, and is characterised in that the same quantity of water that is removed from the container during sludge suction is replenished to the container before the device again is put into full operation.

The invention will now be described in closer detail, with reference to exemplifying embodiments of the invention and the attached drawings, where:

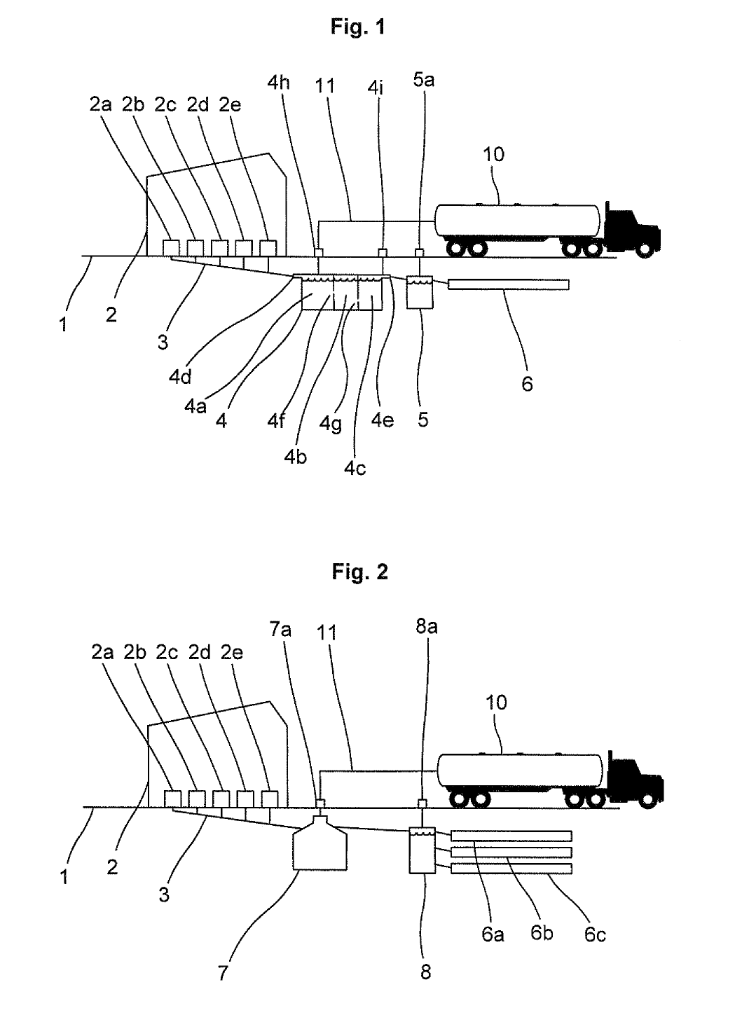

FIG. 1 is a perspective view of a first device where a method according to the present invention may be applied, comprising a sludge separator, a phosphor filter and an infiltration bed;

FIG. 2 is a perspective view of a second device where a method according to the invention may be applied, comprising a small water purification device and a distribution well;

In FIG. 1, a real estate 1 is schematically illustrated, comprising a small house 2. According to a preferred embodiment, the small house 2 is intended for a one or two family household.

In the house 2, a number of blackwater producing units, such as a toilet 2a, exist. Moreover, a number of greywater producing units, such as a sink 2b, a shower 2c, a washing machine 2d and a dishwasher 2e, exist. Such black- and grey-water producing units are herein collectively referred to as waste water producing units.

At least one of the waste water producing units 2a˜2e is connected, via a waste pipe system 3, to a local water purification system. The waste pipe system 3 and the water purification system constitute a permanently installed system for purifying waste water from the building 2.

According to a preferred embodiment, both the blackwater producing and greywater producing units are connected to the water purification system via a joint waste pipe system 3, whereby all waste water becomes blackwater. According to another preferred embodiment, only greywater producing units are connected to the purification system. According to a specifically preferred embodiment, all waste water producing units in the real estate are connected to the purification system.

The local water purification system comprises a sludge separator 4 in the form of a so called three-compartment septic tank, comprising three compartments 4a, 4b, 4c, separated by vertical walls. Waste water flows into the sludge separator 4 through an inlet 4d, and thereafter flows through the compartments 4a-4c one at a time, via holes 4f, 4g at different heights on each wall. The height at which each hole 4f, 4g is arranged is adapted, in a conventional manner, so that floating and sinking particles are separated in several steps as the waste water flows through the three-compartment septic tank. Holes that during operation are arranged in vicinity of the water surface are herein referred to as spillways.

During sludge suction of the sludge separator 4, a sludge suction truck 10 is connected to a connection device 4h via a flexible tube 11, and sludge suction takes place in a manner which is conventional per se. During sludge suction, the three compartments 4a, 4b, 4c of the sludge separator 4 are emptied on sludge as well as on the water in which the sludge is included. It is also common practise that each compartment may be sludge exhausted separately in a corresponding way.

According to the present invention, in a following step the sludge separator 4 is replenished with new water, such as freshwater. It is important that an essentially equal amount of water is supplied as the amount removed together with the separated sludge during sludge suction. This will leave the sludge separator 4 not even partly drained at the end of the procedure, which leads to the water course downstream of the sludge separator not ceasing. Accordingly, the above described problems, in terms of bad efficiency in down-stream arranged purifying steps and insufficient ground water balance, do not arise.

It is essential that replenishing of water takes place before the purification system is again put into full operation after sludge suction. This means that replenishing takes place within sufficiently short a time so that drainage does not appear in consecutive purifying steps. Also, replenishing must take place before so much waste water has flown into the sludge separator 4 so as to risk sludge flight due to the water level in the sludge separator 4 rising.

According to an especially preferred embodiment, replenishing of water takes place immediately or almost immediately after the sludge suction step. According to a very preferred embodiment, the water is replenished from the same sludge suction truck 10 that performs the sludge suction, for instance from a separate fresh water tank arranged in the sludge suction truck 10.

Replenishing may take place through a separately arranged connection device 4h, which is used for the sludge suction step. However, it is preferred that the water is replenished into a compartment 4c that is not the most upstream arranged compartment, preferably to a location in the sludge separator 4 downstream of which water only can exit the sludge separator 4 via one or several spillways. The last compartment 4c in the sludge separator 4, according to FIG. 1, only has one outlet 4e, in the form of a spillway.

By replenishing water to such a location, the risk of down-stream sludge flight is decreased as the water surface rises during replenishing and passes the level of the holes 4f, 4g. Namely, at completion of the water replenishing, the water level has still not passed the level of the spillway 4e, and none or only a small amount of sludge has been able to penetrate further, to purifying steps arranged downstream of the sludge separator 4.

Downstream of the sludge separator 4, the sludge separated waste water flows on to a phosphor separation device 5. Such a device may for instance be in the form of a so called phosphor trap. Other types of separation devices are also useful when applying a method according to the present invention, as long the separation device comprises a container for collecting separated material. In the phosphor separation device 5, the container is a deposit tank in which phosphorous water accumulates during operation. Typically, in this deposit tank other material exists, in solid phase, with the task of binding the chemicals that are active during the precipitation of phosphor. Consequently, during sludge suction precipitated phosphor as well as other solid material is removed.

During normal operation, the phosphor separation device 5 requires sludge suction at regular intervals, during which separated phosphor, other solid material and a certain amount of water is removed from the deposit tank. Thereafter, according to the present invention the deposit tank is replenished, in a way corresponding to the one described above in connection to the sludge separator 4, with water in an amount which is essentially equal to the amount removed together with the separated phosphor. The replenishing may for example take place via the regular connection device 5a for sludge suction.

After the phosphor separation step 5a, waste water flows on to an infiltration bed 6, for infiltration into the ground. Thus, in the purification system different types of steps may occur, such as sludge separator 4 and phosphor trap 5. It is possible to successfully apply the method according to the present invention to those steps which include a container for collecting separated material and which therefore require periodically recurrent sludge suction. Sludge suction is required at different time periods for different types of steps and for steps with different dimensioning, construction, etc. To attain maximal effect of the method according to the invention, it should be applied to those steps that require sludge suction between once every fifth year and twelve times per year.

FIG. 2 principally illustrates a second local water purification system to which a method according to the present invention may be applied. Reference numerals are shared with FIG. 1 for corresponding parts.

In a first step, waste water flows into a so called small water purification device 7 of conventional type per se, that may include, for instance, mechanical, chemical and/or biological purifying steps. The small water purification device 7 requires sludge suction at regular intervals, which is performed via a connection device 7a. In connection to and after the sludge suction, the same amount of water is replenished as is removed, causing the same advantages as the ones described above in connection with the sludge separator 4 and the phosphor trap 5.

Downstream of the small water purification device 7, the purified waste water flows on to a distribution well 8, which distributes the purified waste water over a number of infiltration beds 6a, 6b, 6c. The distribution well 8 also requires sludge suction at regular intervals, which is performed via a connection device 8a. In connection to and after the sludge suction, the same amount of water is replenished as is removed, causing the same advantages as those disclosed above.

The method according to the present invention may also be applied to other steps that constitute components of a permanently installed water local purification system for a small house, under condition that the step comprises a container for collecting separated material. According to the above said, by applying the method to such steps, the problems with bad efficiency in downstream arranged purifying steps due to drainage and insufficient ground water balance in and around the real estate due to sludge suction are solved. For steps in which sludge flight is risked, this problem may be avoided by replenishing the water to a location which only precedes one or several spillways in the step, according to what has been described above.

Above, preferred embodiments have been described. However, it is apparent to the person skilled in the art that many changes may be made to the described embodiments without departing from the scope of the invention. Accordingly, the invention shall not be limited to the disclosed embodiments, but be variable within the frame of the appended claims.

1. Method for maintaining the water balance in a device (4;5;7;8) comprising a container for waste that has been separated from the waste water, the device (4;5;7;8) constituting a part of a permanently installed water purification system for purification of waste water from a building (2), characterised in that the same quantity of water that is removed from the container during sludge suction is replenished to the container before the device (4;5;7;8) again is put into full operation.

2. The method according to claim 1, characterised in that the waste is in the form of sludge or other waste in solid phase.

3. The method according to claim 1, characterised in that, in the water purification system, the device is arranged upstream of an infiltration bed (6a; 6b; 6c).

4. The method according to claim 1, characterised in that the device is a sludge separator (4), comprising at least two compartments (4a; 4b; 4c), and in that water is replenished via a compartment that is not the most upstream arranged compartment.

5. The method according to claim 1, characterised in that water is replenished to a location downstream of which location water may only exit the sludge separator (4) via one or several spillways.

6. The method according to claim 1, characterised in that the container is a sludge separating step in a small water purification device (7).

7. The method according to claim 1, characterised in that the container is a deposit tank (5) intended for, by way of example, phosphor.

8. The method according to claim 1, characterised in that the device is a distribution well (8).

9. The method according to claim 1, characterised in that sludge suction is performed by means of a sludge suction truck (10), and in that the replenishing of water takes place using the same sludge suction truck at one and the same occasion as the sludge suction.

10. The method according to claim 2, characterised in that, in the water purification system, the device is arranged upstream of an infiltration bed (6a; 6b; 6c).

11. The method according to claim 2, characterised in that the device is a sludge separator (4), comprising at least two compartments (4a; 4b; 4c), and in that water is replenished via a compartment that is not the most upstream arranged compartment.

12. The method according to claim 2, characterised in that water is replenished to a location downstream of which location water may only exit the sludge separator (4) via one or several spillways.

13. The method according to claim 2, characterised in that the container is a sludge separating step in a small water purification device (7).

14. The method according to claim 2, characterised in that the container is a deposit tank (5) intended for, by way of example, phosphor.

15. The method according to claim 2, characterised in that the device is a distribution well (8).

16. The method according to claim 2, characterised in that sludge suction is performed by means of a sludge suction truck (10), and in that the replenishing of water takes place using the same sludge suction truck at one and the same occasion as the sludge suction.

17. The method according to claim 3, characterised in that the container is a sludge separating step in a small water purification device (7).

18. The method according to claim 3, characterised in that the container is a deposit tank (5) intended for, by way of example, phosphor.

19. The method according to claim 3, characterised in that the device is a distribution well (8).
